(19) United States
(12) Patent Application Publication
(10) Pub. No.: US 2019/0061858 A1
(43) Pub. Date: Feb. 28, 2019

(54) WINDSHIELD ARRANGEMENT

(71) Applicant: GEOFFREY BRUCE GOODRICK, Sheldon (AU)

(72) Inventor: GEOFFREY BRUCE GOODRICK, Sheldon (AU)

(21) Appl. No.: 16/112,081

(22) Filed: Aug. 24, 2018

Related U.S. Application Data
(60) Provisional application No. 62/549,753, filed on Aug. 24, 2017.

(51) Int. Cl. B62J 17/04; B60J 1/04

(52) U.S. Cl. CPC B62J 17/04; B60J 1/04

(57) ABSTRACT

A windshield arrangement is provided herein for mounting to a steering portion of a vehicle. The arrangement includes a deflector plate configured to be mounted to the steering portion; a windscreen having spaced-apart upper and lower edges, the lower edge generally facing the steering portion; and, at least one mounting element secured to the deflector plate and to the windscreen such that a space is defined therebetween. The windscreen extends beyond the deflector plate with the upper edge of the windscreen being located above the deflector plate. The lower edge of the windscreen is spaced from the steering portion such that, with the motorcycle moving, air flows between the lower edge of the windscreen and the steering portion upwardly along the deflector plate.

### CROSS-REFERENCE TO RELATED APPLICATION

This application claims priority to U.S. Provisional Patent Application No. 62/549,753 filed Aug. 24, 2017, the contents of which are incorporated by reference herein.

### FIELD OF THE INVENTION

The invention relates to a windshield mounting device and method of use. In particular, the invention relates, but is not limited, to a windscreen mounting for a motorcycle or an open vehicle of any type.

### BACKGROUND TO THE INVENTION

Reference to background art herein is not to be construed as an admission that such art constitutes common general knowledge in Australia or elsewhere.

From very early days after the commercial development of the motorcycle and open vehicles generally, there have been attempts at improving rider or driver comfort by providing a windshield or windscreen immediately in front of the rider or driver.

As vehicle speeds increased and longer distances were travelled, manufacturers of such vehicles began to provide windscreens on some models as standard equipment. In addition, fairings or frontal body covers of greater or lesser design complexity began to be incorporated on to open vehicles for greater rider or driver protection against the elements.

As vehicle numbers grew, a market was developed by other suppliers to provide windscreens that were claimed improvements over those provided with factory vehicles, or provided protection on vehicle models that were not originally equipped with windscreens.

With modern vehicle speeds increasing further, open vehicle operators began to experience wind buffeting behind the screen or shield. This is caused by aerodynamic law such that the air displaced by the vehicle moving forward increases the air pressure in the front of the screen or shield and creates a lesser air pressure immediately behind the screen or shield.

During forward motion of the vehicle, air currents move air quickly behind the screen or shield to equalise the air pressure and this rush of air is turbulent in nature, creating a buffeting effect on the rider's torso and especially the head.

Both vehicle manufacturers and accessory manufacturers have created products, or provided auxiliary venting to help direct and control the turbulent air behind the screen or shield, with only a partial degree of success.

Some such manufactured products use specially formed windscreen shapes to try to deflect turbulent air high over the rider's head. To be fully effective, such products need to be high enough such that the rider' s forward vision is directed through the windscreen, but the windscreen has, by the necessity of its design, complex curves which reduce the optical clarity of the rider's vision. It is common for riders to prefer to use a windscreen of reduced height so their forward vision is not impaired. This greatly reduces the effectiveness of the specially formed windscreen to reduce the turbulent air buffeting the rider.

Other attempts to reduce wind buffeting use vents in the windscreen itself to introduce extra air behind the screen. As these vents must be quite small in order not to overly reduce the riders forward vision, and not allow rain or flying insects ingress to strike the vehicle operator, their effect in reducing turbulent air behind the screen is minimal.

Some motorcycle manufacturers who have models with front fairings to help protect the rider from the elements, also provide vents in the front fairing to help direct air toward the rider and help equalise the air pressure behind the windscreen or shield. In practise, these vents do not allow the passage of sufficient air volume to stop turbulent air forming behind the windscreen or shield.

Another more effective solution is to mount the windscreen in such a manner that apart from the placement of mounting elements, the entire lower edge of the windscreen is left open to the frontal air pressure, such that air enters under the screen and is then directed upwards behind the screen with a suitable deflection element to form a full-width air curtain of higher pressure air to smoothly fill the lower air pressure void behind the windscreen. Current products using this method of air control require the vehicle owner to purchase mounting elements, a deflector plate and a windscreen peculiar only to the manufacturer of that product.

Such products, while nominally effective in air control, generally do not follow the aesthetics of the motorcycle manufacturers original design, and limit the vehicle owner to choose only the windscreens styles and heights that are available from that particular supplier.

As most vehicle operators are different heights; it is common for motorcycle manufacturers and accessory manufacturers suppliers to offer a range of windscreen heights and styles to allow the operator to find one that suits them. In addition, some riders will prefer to look over the windscreen while others prefer a higher model windscreen they look through. It is highly desirable therefore for the vehicle owner to have as wide a range as possible of windscreens to choose from, and be able to use the original range of windscreens provided by the vehicle manufacturer, and those windscreens offered by accessory manufacturers.

To gain the maximum benefit from any windscreen at various vehicle speeds, it is desired to provide an adjustment of the mounting height of the windscreen, and desirable that such adjustment is able to be easily made by the vehicle operator during the vehicle's forward motion. It is further desirable that such an adjustment mechanism is compact, able to be fitted to a vehicle as an accessory and partially or fully concealed whilst still providing windscreen mounting height variations in excess of 100 mm.

It is an object of the invention to overcome or ameliorate one or more of the disadvantages or problems described above, or at least provide a useful alternative.

Other preferred objects of the present invention will become apparent from the following description.

SUMMARY OF INVENTION

In one form, although not necessarily the only or broadest form, the invention resides in a windscreen mounting device, the device including:
a deflector plate or deflector element;
mounting elements that provide at one extremity for re-fitment of the vehicle's original windscreen, forward of a deflector plate or deflector element leaving the lower edge of the windscreen substantially open; and
provide fitment to the vehicle at the other extremity; and
the lower portion of the windscreen overlaps the upper portion of the deflector plate or element.

Preferably, the deflector plate or element is an integrated element provided by the vehicle manufacturer. Optionally, the deflector plate is provided by others which may mount to the vehicle's original windscreen mounting provisions.

Preferably, the deflector plate or element extends at a length, height and angle to direct substantial air flow generated from the forward motion of the vehicle, upwards directly and immediately behind the vehicles windscreen.

Preferably, the windscreen mounting elements space the windscreen forward of the deflector plate, so that the lower edge of the windscreen is substantially exposed to airflow resulting from forward movement of the vehicle.

Preferably, the mounting elements have an aerodynamic profile that allows the air flow resulting from the forward motion of the vehicle, to flow with little impediment upwards immediately behind the windscreen.

Preferably, the mounting elements have adjustments, manual or powered, to increase or decrease the height of the windscreen relative to the height of the vehicle's operator.

Preferably, the mounting elements enable the attachment to them of any of the original vehicle manufacturers windscreens designed and manufactured for that model vehicle.

Preferably, the mounting elements enable the attachment to them of any accessory manufacturers windscreens designed and manufactured for that model vehicle.

### BRIEF DESCRIPTION OF THE DRAWINGS

By way of example only, preferred embodiments of the invention will be described more fully hereinafter with reference to the accompanying figures, wherein:

FIG. 1 shows a deflector plate useable with the subject invention;

FIG. 2 shows a mounting element useable with the subject invention;

FIG. 3 shows a windshield arrangement in accordance with the subject invention; and,

FIGS. 4-6 show an adjustable mounting element useable with the subject invention.

### DESCRIPTION OF THE INVENTION

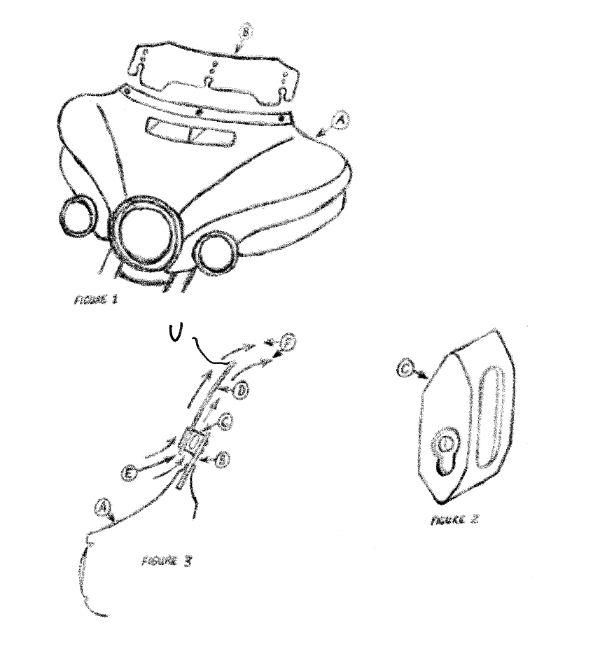

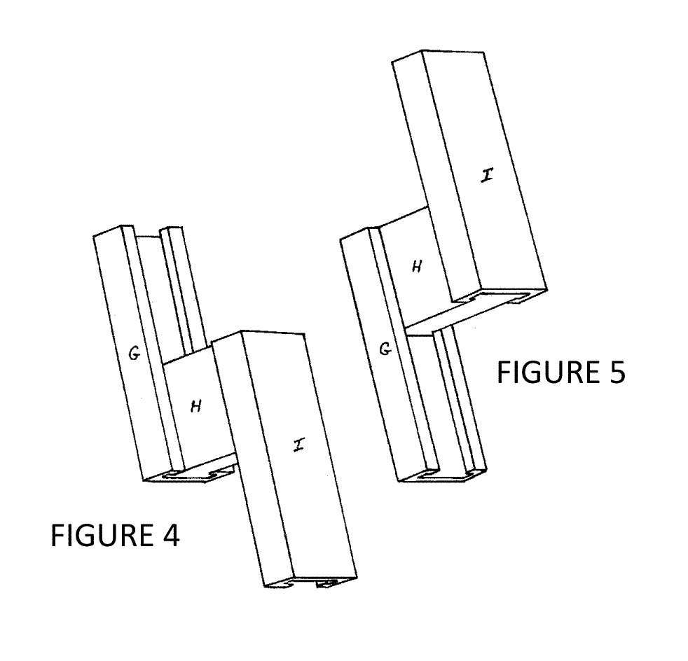

FIG. 1 illustrates a deflector plate ‘B’ which would mount to a vehicle ‘A’ in place of the vehicle's original windscreen, e.g., mount to a steering portion of the vehicle ‘A’, e.g., a steering portion of a motorcycle. The steering portion may include a fairing. The deflector plate ‘B’ may be mounted to the steering portion utilizing at least one windscreen mounting element provided on the steering portion, e.g., factory installed windscreen mounting elements. As shown in FIG. 3, a slot may be provided in the steering portion in which the deflector plate ‘B’ is seated.

As will be recognized by those skilled in the art, the vehicle ‘A’ may be of various forms, particularly open-type vehicles which have a windscreen, such as motorcycles, all-terrain vehicles (ATVs), snow mobiles, automobiles (e.g., open-top, convertibles, etc.), and the like, where a driver is exposed to air flow coming across a windscreen. It is to be understood that for vehicles where there is not a steering portion, like that of a motorcycle, the deflector plate ‘B’ is mounted to the body of the vehicle, e.g., on the hood, cowl, dashboard, and the like, where a windscreen would be normally mounted for that type of vehicle.

FIG. 2 illustrates a non-adjustable mounting element ‘C’ that would project forward of the deflector plate ‘B’, and provide for support, at a distance forward, of the windscreen.

FIG. 3 illustrates in a sectional view, fitment to the vehicle ‘A’ of the windscreen ‘D’ such that air generated by the forward movement of the vehicle, enters under the substantial entirety of the lower edge ‘E’ of the windscreen ‘D’, being mounted forward of the deflector plate ‘B’ by mounting elements ‘C’. Air flow, indicated by arrows ‘F’ is directed by the deflector plate ‘B’ overlapping windscreen ‘D’ to move a substantial volume in an upwards direction immediately behind the windscreen ‘D’, equalizing air pressure behind the windscreen ‘D’ to that of the higher air pressure in the front of the windscreen ‘D’. The windscreen ‘D’ may be the original windscreen (i.e., factory provided) or an after-market replacement part.

As shown in FIG. 3, it is preferred that the upper edge ‘U’ of the windscreen ‘D’ be located above the deflector plate ‘B’ with the windscreen ‘D’ extending upwardly beyond the deflector plate ‘B’. It is also preferred that the lower edge ‘E’ of the windscreen ‘D’ be located spaced from the steering portion.

FIG. 4 illustrates a windscreen mounting slide to be used as a mounting element, providing separation between a deflector plate such as illustrated in FIG. 3, Item ‘B’ and a windscreen such as illustrated in FIG. 3, Item ‘E’. Sliding block ‘G’ and sliding block T are linked by a central block ‘H’ and able to move in relation to each other along planes formed by tee slots or similar slide encapsulations. Sliding block ‘G’ would typically be attached to a deflector plate such as shown in FIG. 1, Item ‘B’ and sliding block T would typically be attached to a windscreen such as shown in FIG. 3, Item ‘E’. FIG. 4 illustrates such a mounting slide in a fully extended down position.

FIG. 5 illustrates the same windscreen mounting slide illustrated in FIG. 4, with the slide travel in a fully extended up position.

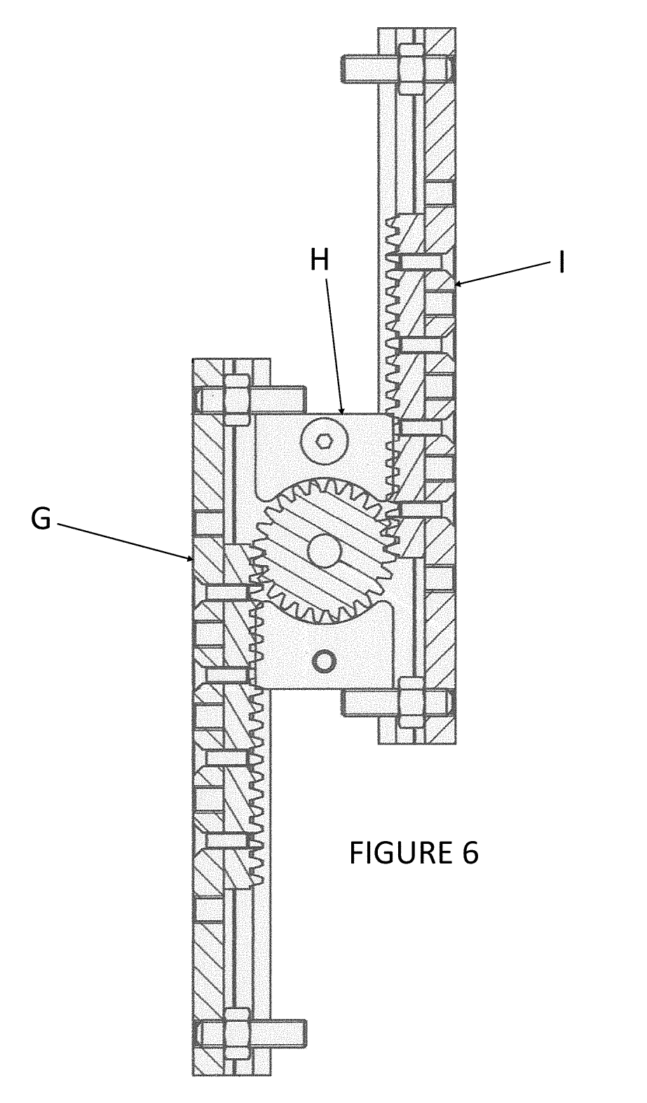

FIG. 6 illustrates a cross sectional view of a control method used to govern the movement of sliding blocks ‘G’ and ‘I’ in relation to the central linking block ‘H’. Typically, a spur gear is partially encapsulated within the central linking block ‘H’ and the spur gear teeth engage gear racks incorporated within the sliding blocks ‘G’ and ‘I’. Rotational movement of the spur gear causes the sliding blocks ‘G’ and ‘I’ to move in opposite directions, providing a much longer length of travel than is possible with a two element slide. Control of the slide movement by rotation of the spur gear to infinitely variable positions, would typically be by the rotation of a hand wheel or a suitable electric motor with reduction gearing. (not shown for clarity).

In this specification, the use of the term ‘windscreen’ also encompasses all other protection elements such as windshields, screens and other devices designed to offer protection to the vehicle operator's upper torso and head from wind, rain and other natural phenomena, when the vehicle is propelled in a forward motion.

In this specification, reference to the term ‘deflector plate or deflector element’ also encompasses all such systems or devices, whether integrated with other vehicle protection elements; or, as separate devices intended to direct an air flow upwards immediately behind a forward placed screen or shield such that the air pressure immediately behind the screen is increased substantially and proportionally to the air pressure on the front of the screen when the vehicle is propelled in a forward motion.

The above description of the present embodiments of the invention is provided for purposes of description to one of ordinary skill in the related art. It is not intended to be exhaustive or to limit the invention to a single disclosed embodiment. Numerous alternatives and variations to the present invention will be apparent to those skilled in the art of the above teaching. Accordingly, while some alternative embodiments have been mentioned specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’ or similar terms are intended to mean a non-exclusive inclusion' such that a method, system or apparatus that comprises a list of elements, does not include those elements solely, but may well include other elements not listed.

What is claimed is:

1. A windshield arrangement for mounting to a steering portion of a vehicle, the arrangement comprising:
a deflector plate configured to be mounted to the steering portion;
a windscreen having spaced-apart upper and lower edges, the lower edge generally facing the steering portion; and,
at least one mounting element secured to the deflector plate and to the windscreen such that a space is defined therebetween, wherein the windscreen extends beyond the deflector plate with the upper edge of the windscreen being located above the deflector plate, and, wherein, the lower edge of the windscreen is spaced from the steering portion such that, with the motorcycle moving, air flows between the lower edge of the windscreen and the steering portion upwardly along the deflector plate.

2. A windshield arrangement as in claim 1, wherein the steering portion includes a fairing.

3. A windshield arrangement as in claim 1, wherein the steering portion includes at least one windscreen mounting element for factory mounting a windscreen.

4. A windshield arrangement as in claim 3, wherein the deflector plate is mounted to the steering portion utilizing the at least one windscreen mounting element.

5. A windshield arrangement as in claim 4, wherein the at least one windscreen mounting element includes a slot, and wherein the deflector plate is mounted to the steering portion with the deflector plate being seated in the slot.

6. A windshield arrangement as in claim 1, wherein the at least one mounting element is adjustable, allowing up and down movement of the windscreen relative to the deflector plate.

7. A windshield arrangement as in claim 6, wherein the at least one mounting element includes first and second sliding blocks slidably mounted to opposing sides of a central linking block.

8. A windshield arrangement as in claim 7, wherein the central linking block includes a spur gear, wherein the first and second sliding blocks each include a gear rack, wherein the teeth of the spur gear engage the gear racks such that rotation of the spur gear causes the first and second sliding blocks to move in opposing directions.

9. A windshield arrangement as in claim 1, wherein the vehicle is a motorcycle.
